(19) United States
(12) Patent Application Publication
(10) Pub. No.: US 2017/0026450 A1
(43) Pub. Date: Jan. 26, 2017

(54) METHOD AND SYSTEM FOR DATA PROCESSING IN MULTIPLE DATA SOURCES BASED ON HTTP PROTOCOL

(71) Applicant: XINYU XINGBANG INFORMATION INDUSTRY CO., LTD., Xinyu City (CN)

(72) Inventor: Xiaohong YAO, Xinyu City (CN)

(21) Appl. No.: 15/008,842

(22) Filed: Jan. 28, 2016

(30) Foreign Application Priority Data
Feb. 4, 2015 (CN) 201510058601.2

(51) Int. Cl. H04L 29/08; G06F 17/30

(52) U.S. Cl. CPC H04L 67/02; G06F 17/30598; G06F 17/30303

(57) ABSTRACT

A system and method for data processing in multiple data sources based on HTTP protocol comprises: A) information receiving device receiving a data-processing request submitted by an application unit based on HTTP protocol, the data-processing request comprising a data source instance, a table entity model and an operation instruction; B) a data source management center distributing the data-processing request to a target database according to a configuration of the data source management center; C) the target database executing the received data-processing request and returning a result of processing to the integrated system; and D) data transforming unit converting the result to an object recognizable to application unit, and returning the object to the application unit. The system and method can reduce data fragments, alleviate developer's burden of data processing, reduce cost of encoding for database query, and enhances the security of the database.

### FIELD OF THE INVENTION

This invention relates to data integration and data processing technology and, more particularly, to a method and system for data processing in multiple data sources based on HTTP protocol.

### BACKGROUND OF THE INVENTION

With the development of information technology and the continuing release and integration of new instance units, coexistence of multiple database storage mediums in one enterprise application system becomes more and more common. Databases involving multiple data sources increase data fragments gradually in an enterprise system, rendering more and more severe problem of so-called information island. In addition, for data-processing with multiple data sources, a conventional project development connects an application unit to the multiple data sources in such a manner that information of the data sources is configured in the application unit so that a required database instance is returned by a corresponding data source, and the application unit can read data from or write data to the corresponding data source directly via the returned database instance. However, in this way, security information such as account and password of the data source will expose in the configuration document of the application unit, which will make it easy to invade the database.

### SUMMARY OF THE INVENTION

To overcome at least one limitation in the prior art described above, a method and system for data processing in multiple data sources based on HTTP protocol are provided.

In one embodiment, a method for data processing in a system integrating therein multiple data sources based on HTTP protocol is provided, said system comprising an information receiving device receiving a data-processing request from an application unit, a data source management center configured to distribute the data-processing request to a target database for processing, and a data transforming unit configured to convert a processing result from said target database to an object recognizable to said application unit, said method comprising: A) said information receiving device receiving a data-processing request submitted by an application unit based on HTTP protocol, said data-processing request comprising a data source instance, a table entity model and an operation instruction; B) said data source management center distributing said data-processing request to a target database according to a configuration of the data source management center; C) said target database executing the received data-processing request and returning a result of said processing to said integrated system; and D) said data transforming unit converting said result to an object recognizable to said application unit, and returning said object to said application.

With the method described above, the integrated system will handle the whole data source transaction specifically, so that the application unit can receive a recognizable result only by submitting a data-processing request in need of client business. As a result, it helps to mitigate the developer's burden of data-processing and simplifies the coding cost of database processing.

In various embodiments, said application unit invokes a remote data source at the other HTTP end via a remote proxy factory provided by Spring to submit said data-processing request to said system, and said system intercepts said data-processing request by using transaction management of Spring. Accordingly, it is possible to realize an invoking to the remote data source, which separates the database from the application unit and reinforces the security of the database.

In various embodiments, said data source management center comprises an individual storage medium for storing information of registered data sources, and said information receiving device submits a data source instance of said data-processing request received from the application to said data source management center to screen out a target database for said instance from a transaction cluster database according to information of a registered data source; and said integration system conducts a judgment according to an individual thread pool management operation thread of respective data source of the data source management center to distribute said data-processing request to an operational instruction structural engine of said object database to generate a SQL statement. This makes it possible to manage multiple data sources in one individual and uniform platform, in which way the developer won't have to manage configuration documents in the application units. Meanwhile, the data fragments in the enterprise application system can be reduced, and invasion of database can be avoided.

In some embodiments, the data-processing request submitted by an application unit may further comprise a condition entity to further screen data in the tables, which facilitates the application layer to add or delete the screen condition flexibly in data processing operation, so as to render an easy expansion of the application unit.

In some embodiments, said operation instructions may comprise adding data, deleting data, modifying data, sorting, removing duplicated part and comparison. Accordingly, the integrated system can further screen out the data in the data table to remove the duplicates and return the result in order to the application unit, which mitigates developer's data processing burden and reduces the coding cost as well.

In addition, a data processing system for multiple data sources based on HTTP protocol is also provided, which comprises:

at least one application unit configured to generate a data-processing request based on HTTP protocol, the data-processing request comprising a data source instance, a table entity model and an operational instructions; an integrated system comprising an information receiving device, a data source management center and a data transforming unit, wherein the information receiving device is configured to receive a data-processing request from an application and transfer the request to the data source management center; the data source management center is configured to distribute the data-processing request to a target database according to a configuration information in a central distribution system so that the distributed request is processed by said target database to return a result; and the data transforming unit is configured to convert said result from the target database to an object recognizable to said application unit and return the converted result to said application unit.

According to the above system, developers only need to submit a data processing request according to requirements of the application unit so as to obtain a returned object recognizable to the application unit, whilst those specific data source's transactions are processed by the integration system, which mitigates the developer's burden of data-processing and simplifies the coding cost of database processing.

In some embodiments, an application unit may invoke a remote data source at the other HTTP end via a remote proxy factory provided by Spring to submit said data-processing request to said integrated system, and the integrated system intercepts said data-processing request of the application unit by using transaction management of Spring. Accordingly, it is possible to invoke remote data source, and the database can be separated from the application unit, which reinforces the security of the database.

In various embodiments, the data source management center comprises an individual storage medium and at least a registered data source. The individual storage medium is configured to stored information of registered data sources, and the information receiving device is configured to submit a data source instance contained in the data-processing request received from the application unit to the data source management center to screen out a target database for the instance from a transaction cluster database according to information of a registered data source. The instruction distributing system is configured to conduct a judgment according to an individual thread pool management operation thread of respective data sources to distribute said data-processing request to an operational instruction structural engine of said object database to generate an SQL statement. Accordingly, a unified management for multiple data sources can be realized without conducting individual configuration for various data sources in an application unit, thereby reducing data fragments and lower down the risk of database deciphering.

In some embodiments, the data-processing request submitted by an application unit may further comprise a condition entity to further screen data from tables.

In some embodiments, the operation instructions may comprise adding data, deleting data, modifying data, sorting, removing duplicated part and comparison. Accordingly, a processing result can be further screened to remove redundant data and the screened data can be sequentially return to the application unit, thus reducing developers' burden in data processing and the cost of coding.

According to the system described above, developers will relax from data-processing burden, cost of conducting query in database (such as coding, executing etc) will be reduced, and the application unit will be isolated from security information of databases, which enhances security of databases in an enterprise application system and lower down risks of invasion.

### BRIEF DESCRIPTION OF THE DRAWINGS

FIG. 1 is a block diagram illustrating a system for data processing in multiple data sources based on HTTP protocol, according to an embodiment of the invention.

FIG. 2 is a flow chart illustrating a method for data processing in multiple data sources based on HTTP protocol according to an embodiment of the invention.

### DETAILED DESCRIPTION

The present invention will be further described in detail in conjunction with the accompanying drawings as follows. The following description provides specific details for a thorough understanding and an enabling description of these implementations. A skilled in the art will understand that the invention may be practiced without some details disclosed herein. Moreover, some well-known structures or functions will not be illustrated or described to their details to avoid unnecessarily obscuring the substantive features which are embodied in the relevant description of various implementations. Furthermore, the terminology used throughout the whole description is intended to be interpreted in its broadest reasonable manner, though it may be used in conjunction with certain specific embodiments of the invention.

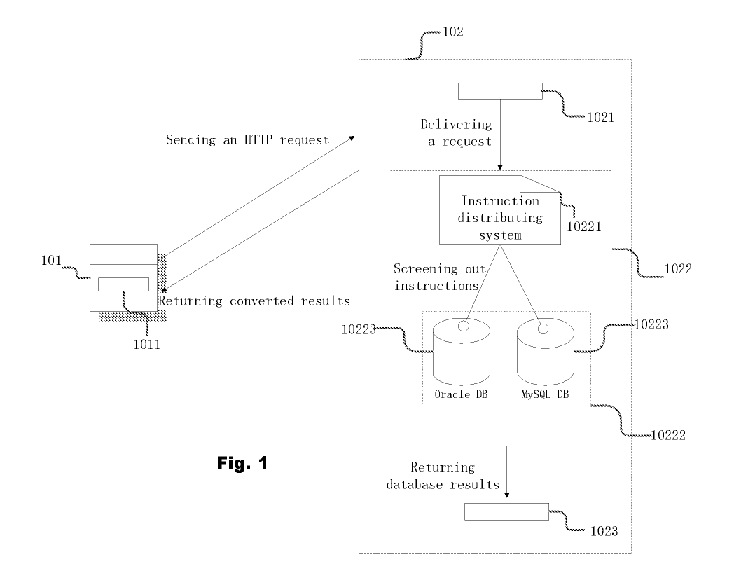

FIG. 1 illustrates a system for conducting data processing in multiple data sources based on HTTP protocol, according to an exemplary embodiment of the invention. As illustrated in FIG. 1, the system comprises an application unit 101 and an integrated system 102. The integrated system 102 comprises an information receiving device 1021, a data source management center 1022 and a data transforming unit 1023. The data receiving device 1021, which may be implemented with a conventional interface circuit, is configured to receive a data processing request from the application unit 101. The request contains a data source instance, a table entity model and operation instructions. The data source management center 1022, which may be implemented with partially or fully implemented by a special purpose computer created by configuring a general purpose computer to distribute the data processing request to a target database in a database cluster according to configuration information in a central distribution system, so that the distributed request is processed by the target database to return a processing result. The data transforming unit 1023 is configured to convert the processing result to an object which is recognizable to the application unit 101, and return the converted result to the application unit 101.

The application unit 101 comprises a data processing unit 1011 which is configured for creating and setting values for a data instance, a table entity model, a condition entity and operation instructions. When it is necessary to carry out an operation on databases, the application unit 101 conducts a setting regarding a data source instance, a table entity model and operation instructions of a request information in the data processing unit 1011, and then sends the data processing request to the integrated system 102 by using a remote proxy factory org.springframework.remoting.httpinvoker.HttpInvokerProxyFactoryBean provided by an open source frame Spring to operate the database.

Spring is an open source frame created by Rod Johnson, which provides a lightweight container with two patterns: “Controlled Inversion” and “Aspect Oriented Programming”. Spring is a layered frame, which is comprised of seven pre-defined units. The units are built on a core container in which how to create, configure and manage Bean is defined. The units constituting a Spring frame can either exist and run alone or combine with other unit to exist and run, the core container provides a basic function for the Spring frame, and contains a main sub-unit BeanFactory which it is implemented in a factory mode. BeanFactory separates the configuration and dependency specification of an application from the codes of the application program by using the “Controlled Inversion” pattern. The HttpInvokerProxyFactoryBean is one of remote proxy factory classes in the BeanFactory, which provides a remote connection service for application units, with which the application units can invoke a Bean instance remotely. As being known to the skilled in the art, Bean is an object-oriented class which can transform a relation-oriented database operation to an object-oriented class operation by defining respective Bean entities, so as to realize object-oriented programming. In one embodiment, for example, a Bean instance of data source instance configuration files in an application unit 101 is defined as follows:

<bean id=“DBEnter”

class=“org.springframework.remoting.httpinvoker.HttpInvokerProxyFactoryBean”>

<property name=“serviceUrl” value=“${httpinvoker.ucenter.url}/aladdinDataCenter”/>
<property name=“serviceInterface” value=“xxx. AladdinDataCenter”/>
</bean>

According to the configuration information described above, the application unit 101 establishes a communication between its own DBEnter and a remote data source at the other end of HTTP based on HTTP protocol. Then the application unit 101 enters a data source instance in its data processing unit 1011 in the following way:

@Resource(name=“DBEnter”)

public AladdinDataCenter dbEnter;

Assuming that a table named “ucenter_access” is defined in a database to which the data source instance corresponds. Then application unit 101 will define a table entity model in its data processing unit 1011 in the following way:

@AladdinTable(name=“ucenter_access”)

public class Access { . . . }

Access ac=new Access( );

After that, application unit 101 will select an operation instruction as required. For example, if data is to be added into database, a data source instance invokes: dbEnter.insert(ac) using the instruction, so that application unit 101 can send a request to the integrated system 102 for inserting a record. Then, application unit 101 invokes a remote data source instance (such as “aladdinDataCenter” described above) at the other end of HTTP by means of a remote proxy factory provided by Spring, namely “HttpInvokerProxyFactoryBean”, according to the invoking address (serviceUrl) and local interface class (serviceInterface) in the configuration files. After application unit 101 calls the operation instruction, information receiving device 1021 of integrated system 102 intercepts the data processing request comprising data source instance (dbEnter), table entity model (ac) and operation instruction (insert), by using transaction management of Spring. Then information receiving device 1021 delivers the request to data source management center 1022 for next processing. Furthermore, it is possible to set a further condition entity for screening data in the table according to data requirements of the application unit 101, for example:

DataConditions condition=new DataConditions( );

dbEnter.setConditions=condition;

Data source management center 1022 comprises an individual storage medium which is configured to store information of registered data sources. To each registered data source 10223, the information stored in the individual storage medium may comprise: database name, database type, database encoding, the physical path for accessing to a database, username, password, accessing pool information, concurrency limits, waiting thread number and releasing time, etc. When integrated system 102 is initiated, the registered data sources will be registered as database services according to the information stored in the individual storage medium 10222.

The storage medium mentioned above is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

For example, assuming there are three registered data sources 10223, when integrated system 102 is started, three database services will be generated as follows, so that the application unit could be able to connect to the data sources using the database services.

http://data.center.server/db1server

http://data.center.server/db2server

http://data.center.server/db3server

The data source management center 1022, upon receiving a data processing request dbEnter, determines whether the type of data source corresponding to the data source instance has been registered according to the invoking address serviceURL. For example, an invoking address serviceURL “http://data.center.server/db1server/aladdinDataCenter”, indicates that “http://data.center.server/db1server” is a registered data source. Then a matched target database is found out from the transaction cluster database according to the provided aladdinDataCenter instance and a database name in the data source information stored in the individual storage medium. Each data source 10223 registered in data source management center 1022 has an individual thread pool management thread, through the configuration of which the data source management center 1022 set an operation identifying information of thread transaction management for each data source. Hence, when a target database is found out, the data source management center 1022 can identify a target database of a node to be accessed and operated by the management operation thread according to data source instance operation instructions, so as to realize a load balance in a database cluster.

For example, for a thread management of MySQL data source, an operation identifying information of a writing node and a reading node is set through the following configuration:

<tx:annotation-driven transaction-manager=“transactionManager”/>

<aop:config proxy-target-class=“true”>

<aop:aspect ref=“datasourceBeforeAdvice”>

<aop:before method=“setMasterDataSource”

pointcut=“execution(*

me.alad.storage.template.mysql.internal.MysqlTemplateImpl.add*(..))

∥ execution(*

me.alad.storage.template.mysql.internal.MysqlTemplateImpl.update*(..))

∥ execution(*

me.alad.storage.template.mysql.internal.MysqlTemplateImpl.delete*(..))

∥ execution(*

me.alad.storage.template.mysql.internal.MysqlTemplateImpl.batch*(..))

∥ execution(*

me.alad.storage.template.mysql.internal.MysqlTemplateImpl.save*(..))

∥ execution(*

me.alad.storage.template.mysql.internal.MysqlTemplateImpl.cancel*(..))”/>

</aop:aspect>
<aop:aspect ref=“datasourceBeforeAdvice”>

<aop:before method=“setSlaveDataSource”

pointcut=“execution(*

me.alad.storage.template.mysql.internal.MysqlTemplateImpl.query*(..))

∥ execution(*

me.alad.storage.template.mysql.internal.MysqlTemplateImpl.get*(..))

∥ execution(*

me.alad.storage.template.mysql.internal.MysqlTemplateImpl.check*(..))”/>

</aop:aspect>

</aop:config>

When the data processing request arrives, instruction distributing system 10221 of data source management center 1022 determines performance of each node in a database cluster according to the configuration information on writing node (setMasterDataSource) and reading node (setSlaveDataSource), and then distributes the data processing request to a related target database according to whether the processing request is a reading request or a writing request. In this way, the data source management center can separate read operations from write operations, so as to balance the load performance of databases in the database cluster. The operational instruction structural engine of a target database generates an SQL statement according to the received instruction, table entity model (ac) and condition entity (condition), and executes the SQL statement to get a processing result set.

Querying based on JDBC always returns a database processing result set which is a ResultSet Object, which cannot be read directly and conveniently by the application unit. To overcome this defect, converting unit 1023 conducts an XML transformation by using a tool (queryForObject) provided by Spring, to convert the database processing result set to an XML set “xsql:request” and return it to the application unit 101. For example, a target database returns a database processing result set contains properties regarding the following fields: lastname (with value dongwen), job (with value coder) and firstname (with value chen), then converting unit 1023 transforms the database processing result set to a format as follows using queryForObject to be returned to application unit 101:

<request>
<parameters>
<lastname>dongwen</lastname>
<job>coder</job>
<firstname>chen</firstname>
</parameters>
</request>

Therefore, the application unit 101 can use xstl and xml format directly to edit front pages, without necessity of circulation and traversal of the database result set to render data on webpages.

According to the system described above, application unit 101 can access to data source 10223 remotely based on HTTP protocol, which achieves a separation of the application unit from database operation, and reduces cost for coding and releases developers' load for data processing. Meanwhile, by a unified registration and storage of all data sources 10223 in the data source management center 1022 for the purpose of a uniform control, data fragments can be reduced, database security can be improved and risk of invasion can be lowered. Further, a flexible data processing of an application unit is available through data converting unit 1023 and setting of operation instructions, thus providing a good expandability of the application.

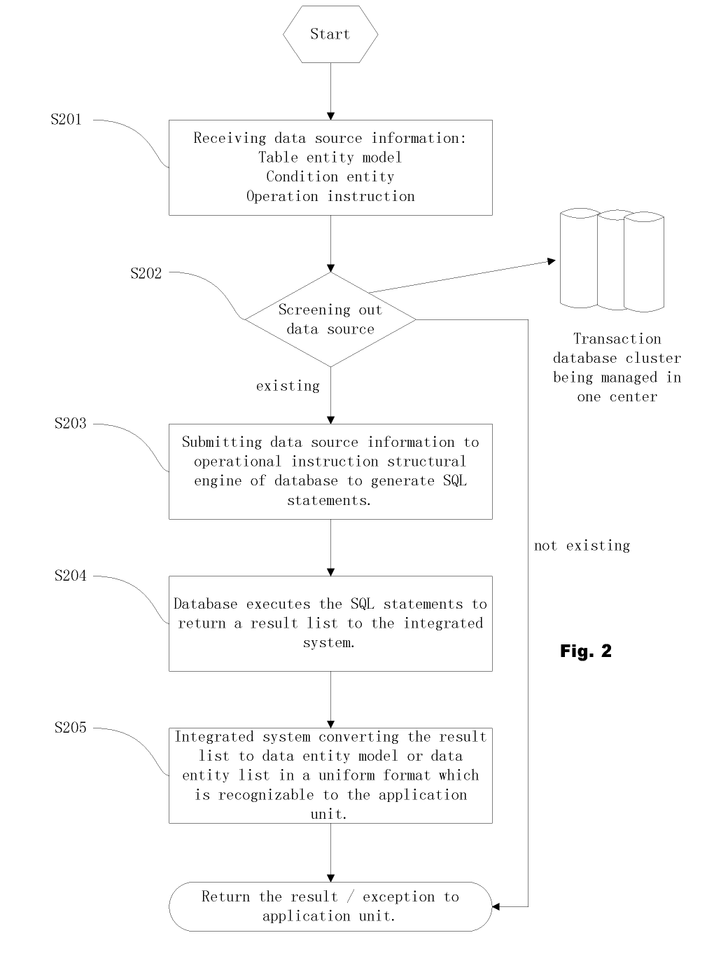

FIG. 2 illustrates a method of data processing in multiple data sources based on HTTP protocol according to an embodiment. As shown in FIG. 2, the method comprises:

Step S201: receiving a data processing request from an application unit.

The application unit comprises a data processing unit, which sends a data processing request to an integrated system when a database operation is needed. A specific process is described as follows:

The application unit has a data source instance Bean defined in its configuration document. The data source instance Bean provides a remote proxy factory for accessing the integrated system by the application unit, for example, “org.springframework.remoting.httpinvoker.HttpInvokerProxyFactoryBean”, a local interface class to be used and an invoking address of the data source instance in the integrated system. When it is necessary for the application unit to conduct an operation on a database, it invokes the remote data source Bean located at the other end of HTTP using the remote proxy factory provided by Spring, according to the configuration information, such as invoking address and local interface class. Meanwhile, the integrated system intercepts the data processing request provided by the application unit, which contains data source instance, table entity model, condition entity and operation instructions, by using transaction management of Spring.

Among the data processing request, the condition entity is optional, which means if the application unit has no need of screening out data from database tables, the condition entity could be null. Under the circumstances, the integrated system will execute the operation instructions to get a result from the target database directly, without a further screening out of data from the databases according to the condition entity.

Step S202: screening out in data source.

The data source management center of the integrated system comprises an individual storage medium for storing information of registered data sources. For each registered data source, the information comprises database name, database type, database encoding, physical path of accessing the database, username, password, accessing pool information, concurrency limits, waiting thread number and releasing time, etc. When the integrated system is initiated, data sources registered in the individual storage medium will be registered as database services to the external.

When the integrated system receives the data processing request from the application unit, it submits the request to the data source management center for a further process. The data source management center judges whether the data source instance is registered or not according to the invoking address of the data source instance. If the data source has been registered, then the data source management center will find out a target database from transaction cluster databases according to the data source instance having the invoking address and database name stored in the individual storage medium. If the data source has not been registered, then the process terminates and returns an abnormal massage to the integrated system.

Step S203: generating SQL statements by the operational instruction structural engine of the target database.

When the target database instance is screened out, the integrated system conducts a judgment according to a configuration of an individual thread pool management operation thread of respective data sources to distribute operation instructions to an operational instruction structural engine of the target database to generate an SQL statement according to a table entity model, a condition entity and an operation instruction.

Step S204: querying the target database to get a database result.

The target database executes the SQL statement to get a database processing result set and return it to the integrated system to conduct a data transforming. When executing an SQL statement, the target database first screens out the table according to the table name and table mapping relationship described by table entity model entered in the application unit, and then screens out data from the table with a condition entity. Finally, the target database conducts operation on the table according to the operation instruction, for example, adding data, deleting data, modifying data, sorting, or removing duplicated part and comparison, so as to get a processing result set.

Step S205: conversion of a database processing result.

Querying based on JDBC always returns a result set of ResultSet Object. The integrated system conducts a data conversion using queryForObject, a tool provided by Spring, to convert the result to a format recognizable to the application unit and returns the recognizable result to the application unit. For example, by using the method (queryForObject) provided by Spring, the integrated system can conduct an XML conversion to convert the result set to an xml set (xsql:request) and return it to the application unit. Therefore, the application unit can use the data in xstl and xml format directly to edit the front pages, without necessity of circulation and traversal explanation of the result set to render data on webpages.

With the system and method described above, the application unit is able to access to the data source remotely by entering a known database source service name into a database instance with the data source service registered based on HTTP protocol, and developers neither have to set an onerous configuration in the application unit nor have to know an exact physical location of the data sources, which makes it possible to avoid indicating a physical location of the data sources in the configuration documents of the application unit. Accordingly, the application unit is separated from the security information of the database, which reinforces the security of the data sources and reduces the risk of invasion. Meanwhile, the data source management center of the system puts the dispersed databases under a unified management and configuration, which helps to reduce data fragments, solves a increasingly severe problem of information island, releases developers from a load of data processing, and makes the coding for database query easier and cheaper.

The foregoing detailed description of various embodiments of the invention has been presented for the purposes of illustration and description. It is not intended to be exhaustive or to limit the invention to the precise form disclosed. Various modifications and variations are possible in light of the above disclosure. It is intended that the scope of the invention be limited not by this detailed description, but rather by the claims appended thereto.

1. A method for data-processing in a system which integrates therein multiple data sources based on HTTP protocol, said system comprising an information receiving device receiving a data-processing request from an application unit, a data source management center comprising a processor and an interface and configured to distribute the data-processing request to a target database for processing, and a data transforming unit configured to convert a processing result from said target database to an object recognizable to said application unit, said method comprising:
A) said information receiving device receiving a data-processing request submitted by an application unit based on HTTP protocol, said data-processing request comprising a data source instance, a table entity model and an operation instruction;
B) said data source management center distributing said data-processing request through the interface to a target database according to a configuration of the data source management center;
C) said target database executing the received data-processing request and returning a result of said processing to said integrated system; and
D) said data transforming unit converting said result to an object recognizable to said application unit, and returning said object to said application.

2. The method of claim 1, wherein the step A) further comprises that said application unit invokes a remote data source at the other HTTP end via a remote proxy factory provided by Spring to submit said data-processing request to said system, and said system intercepts said data-processing request by using transaction management of Spring.

3. The method of claim 1, wherein said step B) further comprises that said data source management center comprises an individual storage medium for storing information of registered data sources, and said information receiving device submits a data source instance in said data-processing request received from the application to said data source management center to screen out a target database for said instance from a transaction cluster database according to information of a registered data source, and
said data source management center conduct a judgment according to an individual thread pool management operation thread of respective data source to distribute said data-processing request to an operational instruction structural engine of said object database to generate a SQL statement.

4. The method of claim 1, wherein said data-processing request further comprises a condition entity.

5. The method of claim 1, wherein said operational instructions comprises adding data, deleting data, modifying data, sorting, removing duplicated part, and comparison.

6. A data processing system for multiple data sources based on HTTP protocol, comprising:
at least one application unit configured to generate a data-processing request based on HTTP protocol, said data-processing request comprising a data source instance, a table entity model and an operational instruction;
an integrated system comprising an information receiving device, a data source management center and a data transforming unit, wherein said information receiving device is configured to receive a data-processing request from an application and transfer the request to said data source management center; said data source management center is configured to distribute the data-processing request to a target database according to a configuration information in a central distribution system of said data source management center so that the distributed request is processed by said target database to return a result; and said data transforming unit is configured to convert said result from said target database to an object recognizable to said application unit and return the object to said application unit.

7. The system of claim 6, wherein said application unit invokes a remote data source at the other HTTP end via a remote proxy factory provided by Spring to submit said data-processing request to said integrated system, and said integrated system intercepts said data-processing request by using transaction management of Spring.

8. The system of claim 6, wherein said data server management center comprises an individual storage medium and at least a registered data source, wherein
said individual storage medium is configured to store information of registered data sources, and said information receiving device is configured to submit a data source instance contained in said data-processing request received from the application unit to said data source management center to screen out a target database for said instance from a transaction cluster database according to information of a registered data source; and
said instruction distributing system is configured to conduct a judgment according to an individual thread pool management operation thread of respective data sources to distribute said data-processing request to an operational instruction structural engine of said object database to generate an SQL statement.

9. The system of claim 6, wherein said data-processing request further comprises a condition entity.

10. The system of claim 6, wherein said instructions comprise adding data, deleting data, modifying data, sorting, removing duplicated part, and comparison.
